(19) United States
(12) Patent Application Publication
(10) Pub. No.: US 2010/0023262 A1
(43) Pub. Date: Jan. 28, 2010

(54) Driftline navigation system

(76) Inventor: Mark T. Haney, Tallahassee, FL (US)

Correspondence Address: WILEY HORTON, 215 SOUTH MONROE STREET, 2ND FLOOR, TALLAHASSEE, FL, 32301, US

(21) Appl. No.: 12/220,370

(22) Filed: Jul. 24, 2008

(51) Int. Cl. G01C 21/22

(52) U.S. Cl. 701/213; 701/207

(57) ABSTRACT

A method for determining the drift vector in a watercraft and then graphically projecting an anticipated drift line for a specified target point. The inventive method is preferably carried out by modifying existing GPS plotters. The user initiates a drift vector determination. A memory device receiving positional data then records the starting position of the watercraft and an ending position of the watercraft a suitable amount of time later. The starting and ending points are then used to calculate a drift vector, which includes at least the orientation of the drift and preferably also information abut the speed of the drift. This information is stored in a memory device. A graphical display is used. At some point the user defines a target point, which is shown within the graphical display. The drift vector information is retrieved from memory and a drift line is projected from the target point in a direction which is 180 degrees away from the direction of the drift vector. The user can then maneuver onto the projected drift line, with the knowledge that if the watercraft is allowed to drift at that point, it will drift over the target point.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of navigation. More specifically, the invention comprises a drift determination and compensation method primarily intended for use in drifting watercraft.

2. Description of the Related Art

FIG. 1 shows a plan view of vessel 10 adrift in open water. Two forces primarily determine how the vessel will move. These are wind acting upon the portion of the vessel lying above the waterline and current acting on the portion of the vessel lying below the waterline. These two forces combine to move the vessel along drift vector 14.

Those skilled in the art of navigation are able to discern the likely effects of wind by watching the orientation and motion of waves 12. However, the current is difficult to discern. It is often a function of wind in other areas, tides, and established ocean currents. Even if the current is known, it is difficult for most persons operating a vessel to accurately predict the orientation of drift vector 14.

However, the use of GPS receivers now allows the position of the vessel itself to be accurately determined. Many vessels now use an integrated “GPS plotter,” which combines GPS positional data with chart data and in some instances depth readings. FIG. 2 shows an example of such a device. GPS plotter 16 comprises case 20 attached to mount 18. A graphical display 22 is provided, which at present is typically a backlit LCD display. Power button 26 turns the device on and off. Input buttons 24 allow a user to select a variety of functions, such as zooming in or out on the chart display, inputting waypoints, etc.

Those skilled in the art will know that the presence of a device such as shown in FIG. 2 allows a helmsman to know (1) the vessel's position; (2) the vessel's speed; and (3) the vessel's current heading. However, this knowledge does not directly solve the problem of determining the drift vector shown in FIG. 1.

FIG. 3 provides a situation where it would be desirable to know the drift vector. Target point 28 is a known position where the user wishes to place the vessel. In this example the user wishes to maintain the vessel over target point 28. One way to do this is to drop an anchor and allow the boat to drift over the target as the anchor line pays out.

A skilled boat operator knows that the anchor must be dropped upwind. The wind direction can be discerned from wave action. Thus, the operator maneuvers the vessel to anchor point 30 and drops the anchor to the bottom. The anchor line is then extended to allow the boat to drift. The presence of a current—in the direction indicated by the arrow—causes the vessel to drift along actual drift vector 14 and ultimately come to rest at stabilized location 32.

The reader will observe that stabilized location 32 is significantly removed from target point 28. An experienced user will note the error. He or she will then pull up the anchor and maneuver the boat to a new anchor-dropping point that compensates for the orientation of the drift vector. This often becomes an iterative process, with two or more attempts required to actually place the vessel over the target point.

The iterative anchoring process produces noise and generally disturbs the area around the target point. As the operation described is often performed incident to fishing, noise is undesirable. It would be preferable to provide a system which allows the target point to be reached while dropping the anchor only once.

### BRIEF SUMMARY OF THE PRESENT INVENTION

The present invention comprises a method for determining the drift vector of a watercraft and then graphically projecting an anticipated drift line for a specified target point. The inventive method is preferably carried out by modifying existing GPS plotters. The user initiates a drift vector determination. A memory device receiving positional data then records the starting position of the watercraft and an ending position of the watercraft a suitable amount of time later. The starting and ending points are then used to calculate a drift vector, which includes at least the orientation of the drift and preferably also information abut the speed of the drift. This information is stored in a memory device.

A graphical display is used. At some point the user defines a target point, which is shown within the graphical display. The drift vector information is retrieved from memory and a drift line is projected from the target point in a direction which is 180 degrees away from the direction of the drift vector. The user can then maneuver onto the projected drift line, with the knowledge that if the watercraft is allowed to drift at that point, it will drift over the target point.

Additional features may be added as well. Visual distance cues may be added along the projected drift line. Information regarding the depth and other factors can be used to calculate a suitable anchoring point along the drift line. This anchoring point can be graphically depicted so that the user knows where to drop anchor in order to drift over the target point.

### BRIEF DESCRIPTION OF THE SEVERAL VIEWS OF THE DRAWINGS

FIG. 1 is a plan view, showing the components of drift.

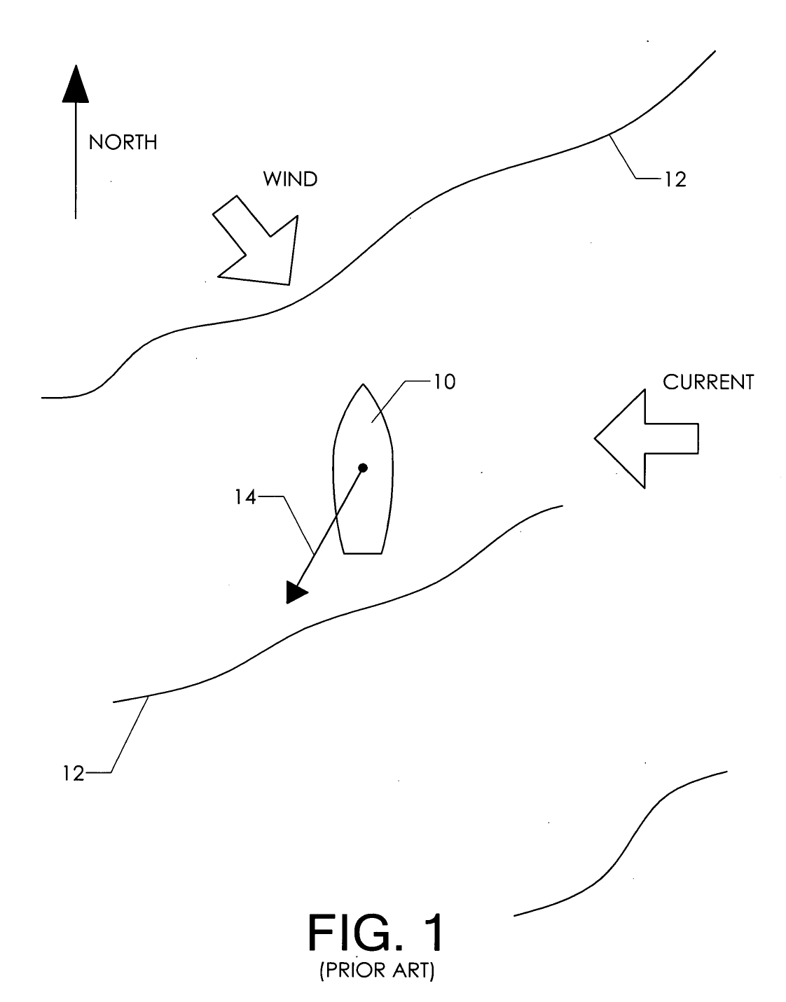

FIG. 2 is a perspective view, showing a prior art GPS plotter.

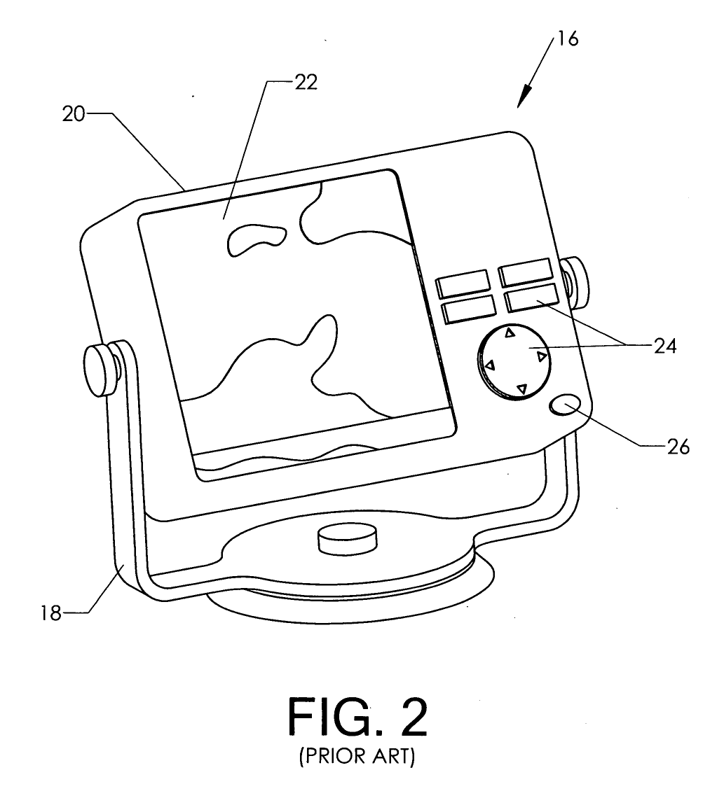

FIG. 3 is a plan view, showing an anchoring operation.

FIG. 3B is a schematic view, showing the calculation of a projected drift vector.

FIG. 4 is a plan view, showing the calculation of a projected drift vector.

FIG. 5 is a split view, showing a GPS plotter display and a plan view of a drifting vessel.

FIG. 6 is a plan view, showing the operation of a GPS plotter configured to carry out the present invention.

FIG. 7 is a plan view, showing the projection of a drift line.

FIG. 8 is a plan view, showing the use of a drift line to maneuver a vessel.

FIG. 9 is a split view, showing an anchoring operation and the projection of an anchoring band on a GPS plotter.

FIG. 10 is a plan view, showing the addition of a steering prompt.

### REFERENCE NUMERALS IN THE DRAWINGS

| | | | |
|---|---|---|---|
| 10 | vessel | 12 | wave |
| 14 | drift vector | 16 | GPS plotter |
| 18 | mount | 20 | case |
| 22 | display | 24 | input buttons |
| 26 | power button | 28 | target point |
| 30 | anchor point | 32 | stabilized location |
| 34 | projected drift vector | 36 | establish drift button |
| 38 | vessel display | 40 | initial position |
| 42 | drifted position | 44 | cursor control |
| 46 | cursor | 48 | target |
| 50 | apply drift button | 52 | drift line |
| 54 | hash mark | 56 | vessel track |
| 57 | surface | 58 | bottom |
| 60 | anchor | 62 | anchor line |
| 64 | 50 m mark | 66 | 100 m mark |
| 68 | anchoring band | 70 | steering prompt |
| 72 | start point | 74 | end point |

### DETAILED DESCRIPTION OF THE INVENTION

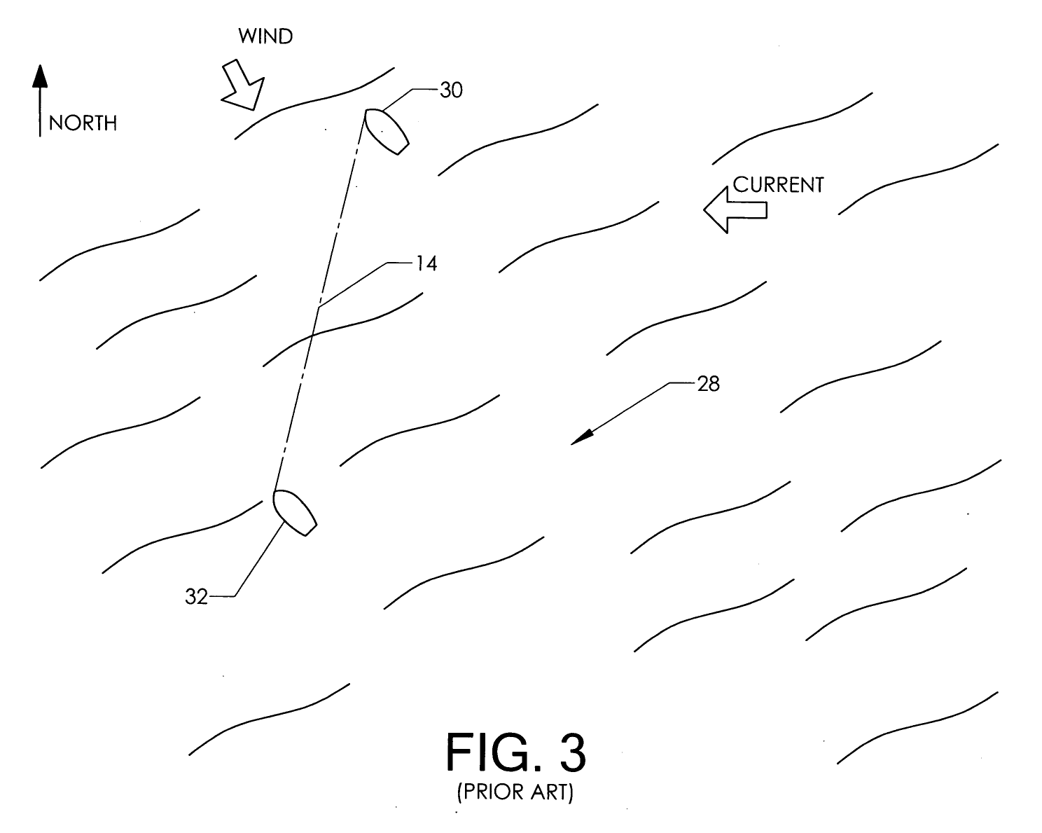

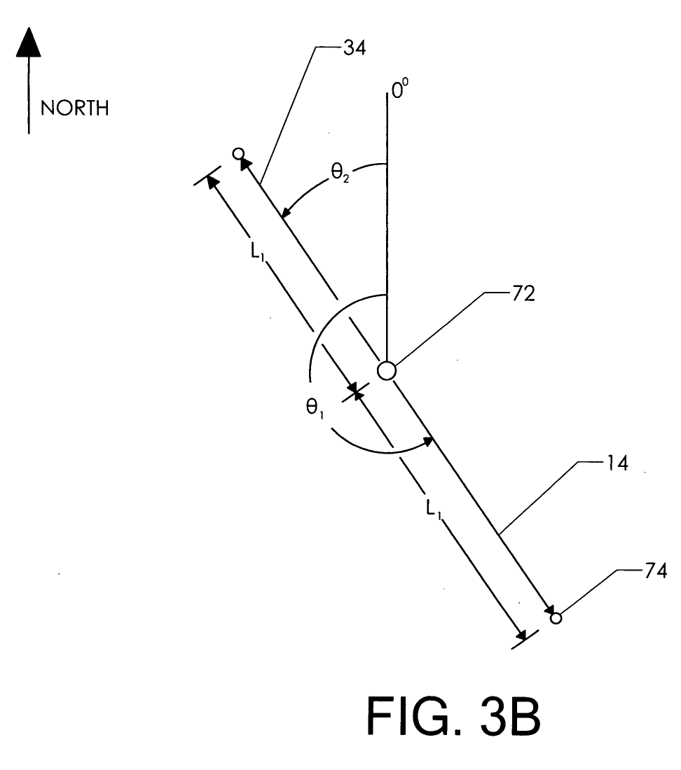

FIG. 3B shows a graphical depiction of the invention's basic function. A position determining device—typically a GPS receiver—can be used to monitor a vessel's position and thereby determine an actual drift vector. The process is started by taking the vessel's position at start point 72. The position is then determined at a second, later time. This is denoted as end point 74 in the view. The time interval between the start and end points should be sufficient to allow an accurate drift measurement. This will depend largely on the magnitude and consistency of the vessel's drift (which will be explained in more detail subsequently).

A simple way of establishing a drift vector is simply comparing the position of end point 74 to the position of start point 72. The difference in these positions will establish actual drift vector 14. Actual drift vector 14 has a magnitude L₁ and a direction θ₁ (the direction is shown using the navigational convention of north being 0 degrees). Projected drift vector 34 may then be calculated. The projected drift vector has the same starting point as the actual drift vector and the magnitude of the projected drift vector is equal to the magnitude of the actual drift vector. However, the direction (or heading) of the projected drift vector is determined by subtracting 180 degrees from the heading of the actual drift vector. In other words, θ₂=θ₁−180°.

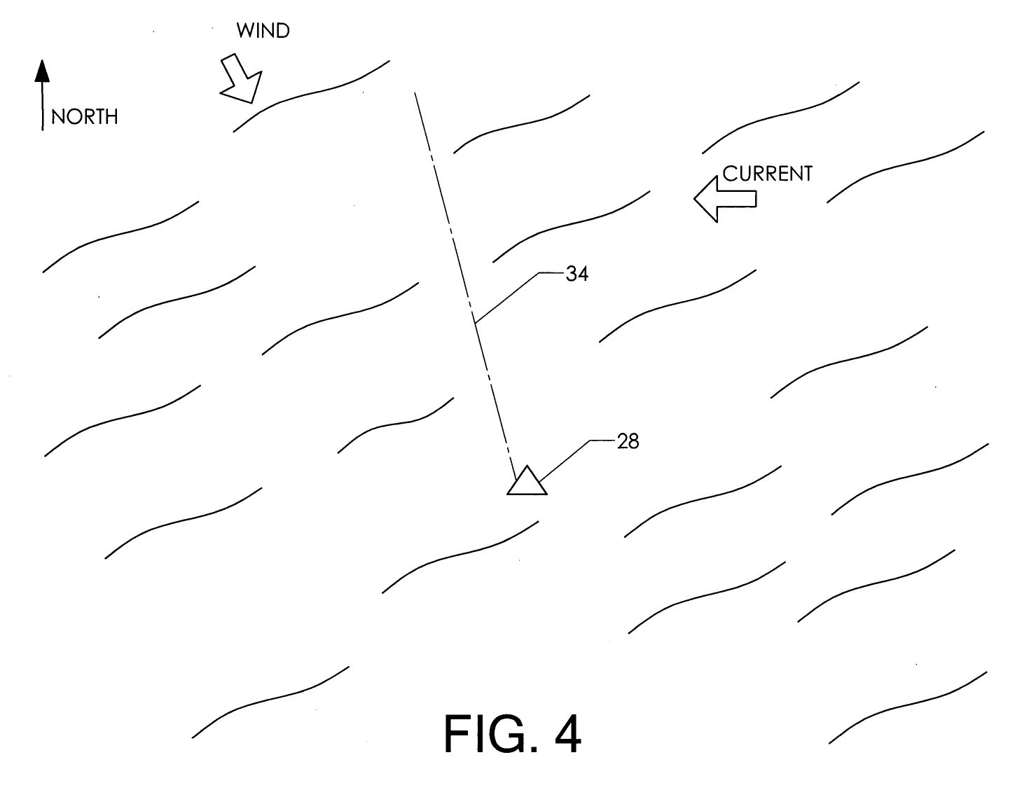

FIG. 4 shows how the projected drift vector can be used. If the user defines an arbitrary target point 28, the start point of the projected drift vector can be mathematically translated to lie upon the target point. The heading and magnitude of the vector remain the same. The result is the location shown for projected drift vector 34 in FIG. 4.

Those skilled in the art will realize that projected drift vector 34 is quite useful in maneuvering the vessel. If the vessel's operator places the vessel anywhere along the projected drift vector and kills the vessel's momentum, then the vessel will drift along the projected drift vector and eventually pass over target point 28.

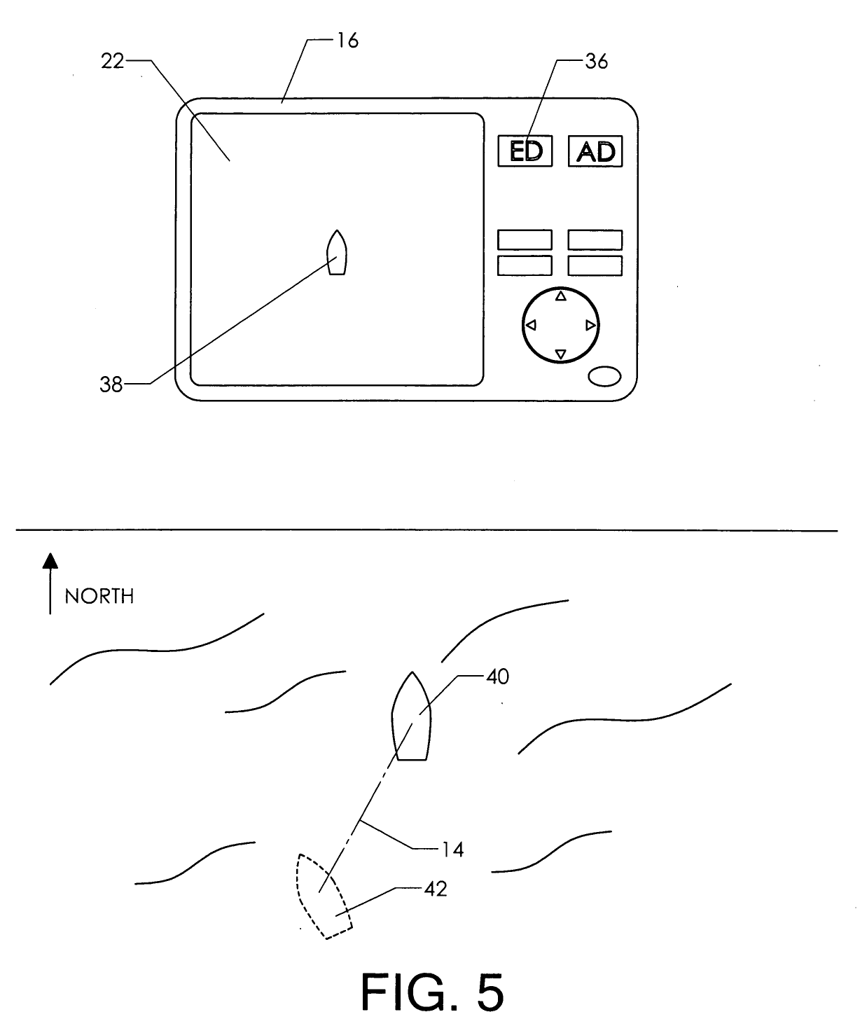

Of course, the inventive process preferably includes user interface features allowing its convenient operation. FIG. 5 illustrates an exemplary embodiment of a user interface. Those skilled in the art will realize that a virtually infinite variety of user interfaces could be provided. Thus, the examples illustrated should properly be viewed as only a few of the many possibilities.

FIG. 5 is a split view. The upper view shows a GPS plotter modified to carry out the invention. The lower view shows a drifting vessel. The GPS plotter is provided with an establish drift button 36. Once an operator kills the vessel's forward momentum, he or she depresses this button, which initiates the drift measurement process. The lower view shows the vessel drifting from initial position 40 to drifted position 42. Actual drift vector 42 is then determined using any suitable method.

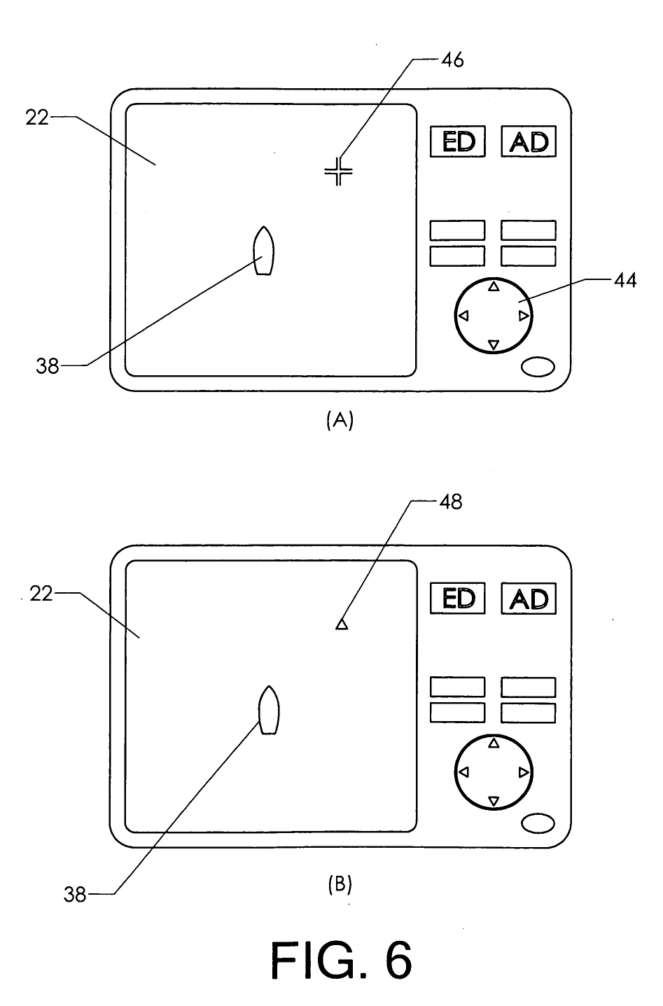

FIGS. 6-8 show how the projected drift vector can be used in navigation. In FIGS. 6(A) and (B) the user defines a target point. In FIG. 6(A) the user employs cursor control 44 to move cursor 46 to a desired location. The user then selects this location, which appears as target 48 in FIG. 6(B) (target points can be entered in many different ways an are often entered as latitude and longitude coordinates without using a cursor). Many GPS plotters are configured to show a vessel display 38, and to have the other objects in display appear relative to the vessel (as opposed to some other frame of reference, such as making them appear relative to true north).

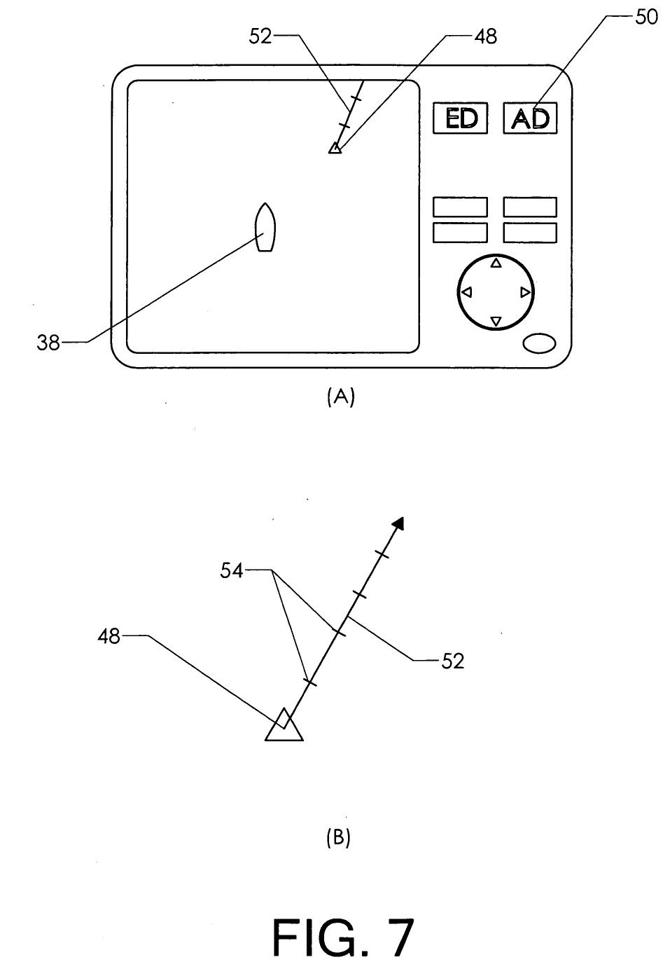

FIG. 7 shows how the user employs the projected drift vector. In FIG. 7(A), the user applies the projected drift vector to an active target point by selected the apply drift button 50. This button causes drift line 52 to appear, with its starting point located on target 48. Drift line 52 has the same heading as the projected drift vector. The reader will note that the heading of drift line 52 in FIG. 7(A) is different from the example of FIGS. 3(A) and 4, which represents a difference in the current and wind forces present when the drift measurement of FIG. 5 was taken.

FIG. 7(B) shows the display of the target and drift line in greater detail. The length of drift line 52 is possibly related to the magnitude of the projected drift vector, but it may also be completely unrelated. It may be preferable to extend the drift line to an arbitrary length. Hash marks 54 may be provided along the drift line to show the distance to target 48. As an example, the hash mark nearest to target 48 could display a distance of 50 meters. The next hash marks could then show 100 m, 150 m, 200 m, and so on. The drift line can be extended off the edge of the display if desired.

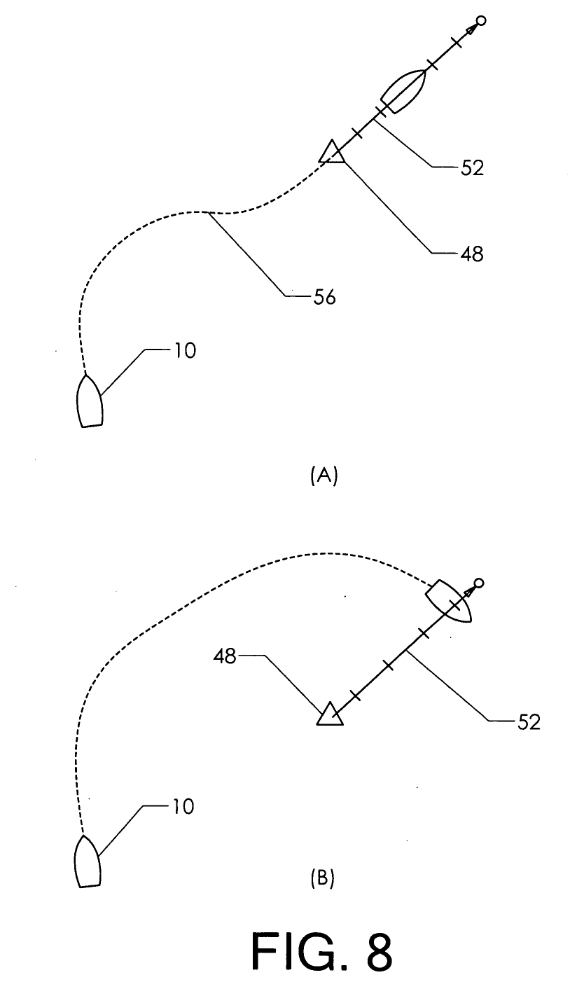

FIG. 8 illustrates two of the many possibilities for using drift line 52. FIG. 8(A) represents an anchoring scenario. The user wishes to anchor the vessel in a position where—once the anchor is set and the anchor line is extended—the vessel will lie over target 48. The user therefore steers vessel 10 along vessel track 56 as shown. When the vessel reaches a suitable distance along drift line 52, the anchor is lowered and the vessel is allowed to drift over target 48 as the anchor line is let out.

FIG. 8(B) represents a different scenario, in which a fisherman wishes to pass baited lines over target 48. In this scenario the user does not wish to create noise and wave disturbances in the vicinity of the target. The user therefore pilots the vessel in a wide circle around the target and intersects drift line 52 well away from target 48. The user then deploys the fishing tack and allows the vessel to drift over the target.

Some users may wish to have an extension of the drift line appear downstream of target 48. This can easily be done using the graphical display. The user can then continue to observe the vessel's actual drift in comparison to the drift line even after the vessel has passed over the target. Other graphical enhancements can be provided. As an example, arrows indicating the direction of drift could be placed on the drift line or elsewhere in the display.

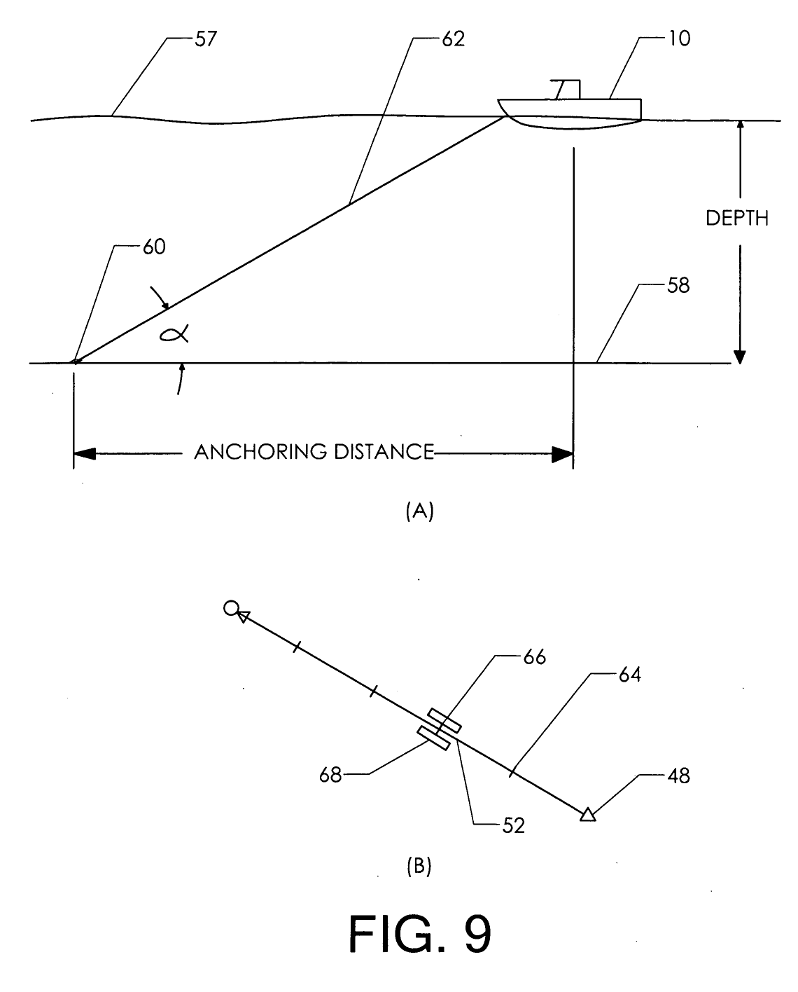

As the anchoring situation is a common one, it warrants further discussion. FIG. 9 illustrates an anchoring operation. FIG. 9(A) shows an elevation view of vessel 10 anchored in position. Vessel 10 rides along surface 57, while anchor 60 rests on bottom 58. If the depth of the water is known, an optimum angle α for anchor line 62 can be calculated to a reasonable degree of certainty. The optimum angle allows a good setting force to be applied to the anchor without using an unduly long anchor line. This then allows the calculation of the anchoring distance, which represents the amount of drift the vessel will experience away from the anchor (which is sometimes referred to as a downwind drift but which, of course, is actually a function of wind and current).

The determination of the anchoring distance can be calculated using the known depth (which can be provided by an integrated or separate depth finder, as well as simply being entered by the user from a chart or other data source). FIG. 9(B) shows one way in which the anchoring distance information could be graphically displayed to the user. This view shows target 48 and drift line 52 extending away from the target. This particular embodiment has hashmarks shown. It also displays an anchoring band 68, which is preferably set out in a distinctive graphic or color. The center of the anchoring band in this example lies between 50 m mark 64 and 100 m mark 66. The band actually covers a distance of about 30 m, indicating that a successful anchoring operation can likely be carried out anywhere within this band. If the user then drops anchor with the vessel's position lying along drift line 52 and lying within anchoring band 68, the anchor line can be let out and the boat should drift down the drift line until it lies over target 48. The anchor line can then be secured so that the vessel remains in position over the target.

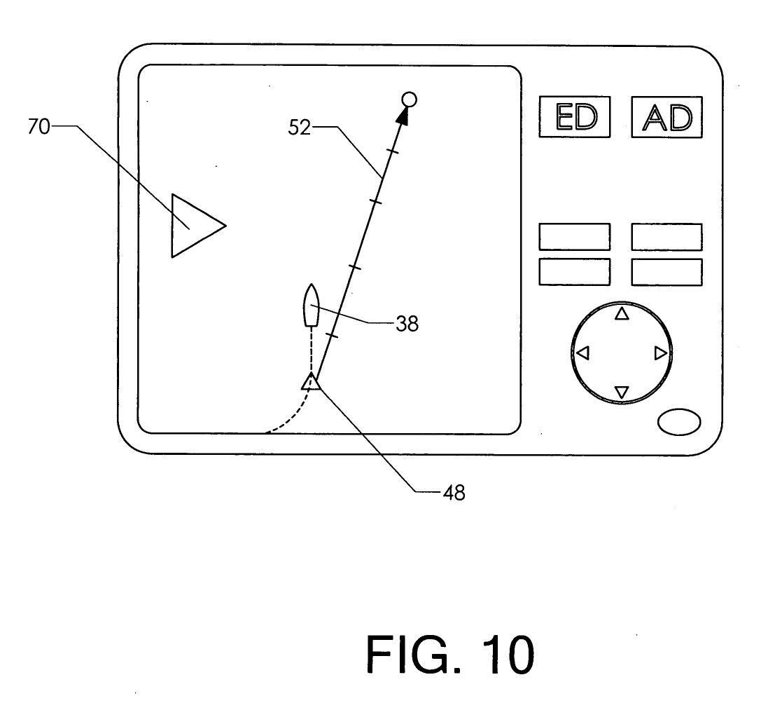

Those skilled in the art will realize that many enhancements can be added to the inventive processes thus disclosed. FIG. 10 shows one such enhancement. The vessel is maneuvering along drift line 52. The vessel has passed over target 48 and is attempting to travel along the drift line. The reader will note, however, that vessel display 38 has deviated to the left of the drift line. Steering prompt 70 appears indicating that the user should steer to the right. If the user deviates to the left of the drift line, a steering point indicating that the user should steer to the left would appear. Audible signals, or other types of signals, could be substituted for the graphical ones.

Some users may prefer to know the actual distance the vessel is from the drift line. For example, a GPS plotter can project the vessel's path based on its current heading. This projected path can be intersected with the drift line and a distance from the vessel to the drift line can then be calculated. The boat operator may wish to know this distance so that he or she can smoothly decelerate as the vessel approaches the drift line.

Having thereby received an explanation of the invention's fundamental operative features, the reader may wish to know some more detail about certain operations. A simple two-point method of determining the actual drift vector was explained previously. Many other methods could be used for this. For instance, many GPS receivers provide track monitoring at a rate of between 1 and 10 samples per second. This is used to generate instantaneous velocity vectors at the same rate. These vectors can be averaged over time to create a good approximation of the drift angle and speed. These vectors can also be used to determine how many samples should be gathered before determining the actual drift vector. A slow drift rate may require the averaging of samples over a relatively long period, such as 5 minutes. A fast drift rate may provide sufficient data in 1 minute or less. An algorithm running on a computing device can make this determination and automatically adjust the measurement period. On the other hand, the device can simply allow a user to select the period. The device can even allow the user to manually start and manually stop the measurement period.

The calculations and displays discussed obviously require the presence of a computing device and an associated memory. Modern GPS plotters already have an internal computing device and associated memory (as well as sophisticated display technology). Thus, the invention can be implemented simply by modifying the software of an existing GPS plotter.

The drift line needed to accurately predict the vessel's drift will not—of course—remain constant. Changing wind and current conditions will eventually cause the drift line to become inaccurate. It is therefore preferable to recompute the drift line from time to time. A prompt can be provided to remind the user of the need to create a new drift line after a fixed interval. The software can also predict the likely interval by noting the variability and strength of the wind and current forces. It is even possible to provide corrections to the direction of the drift line by observing continuously taken position samples and noting how they deviate from the projected drift.

One good approach to evaluating the continued validity of the drift line is to evaluate the linearity of the boat's actual drift over time. If the drift remains constant, then position samples being taken by a GPS device will all lie approximately along a single line. If the drift varies, however, the sample points will begin to curve away from the line. An error threshold can be defined so that the user is prompted once a significant error is detected.

The GPS device will typically measure and store position data continuously. Thus, when the error threshold is exceeded, the device can be configured to use the last portion of the data collected to determine a new drift vector and a new drift line. The user can be prompted to initiate such a recomputation, or it can be performed automatically.

Some users may prefer other variations in the graphical display. As an example, the hashmarks shown along the drift line could be used to display time to the target rather than distance from the target. The expected drift velocity is known from the samples taken. Thus, it is possible to place a hashmark at a distance along the drift line from which it will take the vessel 1 minute to drift over the spot (as well as 5 minutes, 10 minutes, and so on). The actual time-to-target and distance-to-target can be displayed as well.

Those skilled in the art will know that the cursor functions found in most graphical displays allow the inventive process to be easily used in many ways. As an example, once a drift line is presented, the user can employ the cursor to select two points along the drift line. The time to drift from the first point to the second point can then be computed and displayed to the user.

Finally, although the invention has been presented in the context of sport fishing and pleasure boating operations, it should not be seen as limited to these types of operations. Many commercial vessels could employ the invention for docking and slow maneuvering. Military applications—particularly in the field of anti-submarine warfare—are also possible.

Although the preceding description contains significant detail, it should not be construed as limiting the scope of the invention but rather as providing illustrations of the preferred embodiments of the invention. The inventive device could be realized in many different ways. Thus, the scope of the invention should be fixed by the following claims rather than the examples given.

Having described my invention, claim:

1. A navigation aid allowing a user to predict the drift of a vessel, comprising:
a. providing a position determining device capable of accurately determining said vessel's position;
b. providing a graphical display capable of displaying said vessel's position to said user and further capable of displaying graphical elements;
c. providing a computing device having an associated memory;
d. determining a first position of said vessel at a first time;
e. determining a second position of said vessel at a second time which is later than said first time;
f. computing an actual drift vector starting at said first position and a first heading representing said change between said first position and said second position;
g. computing a projected drift vector having a start point lying on said first position and a second heading computed by subtracting 180 degrees from said first heading;
h. saving said projected drift vector in said memory;
i. at some point specifying a target; and
j. displaying said projected drift vector on said graphical display by placing said projected drift vector start point on said target and extending a drift line away from said target along said second heading.

2. A navigation aid as recited in claim 1, further comprising making the length of said drift line proportional to the length of said projected drift vector.

3. A navigation aid as recited in claim 1, further comprising displaying hashmarks along said drift line to indicate distance.

4. A navigation aid as recited in claim 1, further comprising displaying hashmarks along said drift line to indicate time.

5. A navigation aid as recited in claim 1, further comprising:
a. providing a current depth to said computing device;
b. computing an anchoring distance corresponding to said current depth;
c. computing an anchoring position along said projected drift vector; and
d. displaying said anchoring position along said drift line.

6. A navigation aid as recited in claim 5, wherein said current depth is automatically provided to said computing device by a depth finding device.

7. A navigation aid as recited in claim 1, further comprising:
a. determining the length of time that has passed between the calculation of said projected drift vector and the present time; and
b. when said length of time that has passed between the calculation of said projected drift vector and the present time exceeds a predetermined limit, informing said user that said projected drift vector should be recomputed.

8. A navigation aid as recited in claim 1, wherein the interval between said first time and said second time is determined by said user.

9. A navigation aid as recited in claim 1, wherein the interval between said first time and said second time is determined by:
a. monitoring the distance between said first position and said second position; and
b. determining said second time to be the instant at which said distance between said first position and said second position exceeds a predetermined threshold.

10. A navigation aid allowing a user to predict the drift of a vessel, comprising:
a. providing a GPS plotter capable of accurately determining said vessel's position;
b. providing a graphical display within said GPS plotter capable of displaying said vessel's position to said user and further capable of displaying graphical elements;
c. providing a computing device in said GPS plotter;
d. providing a memory within said GPS plotter;
e. providing user input devices within said GPS plotter;
f. upon receiving an input from said user to initiate a drift determination, determining a first position of said vessel at a first time;
g. determining a second position of said vessel at a second time which is later than said first time;
h. computing an actual drift vector starting at said first position and a first heading representing said change between said first position and said second position;
i. computing a projected drift vector having a start point lying on said first position and a second heading computed by subtracting 180 degrees from said first heading;
j. saving said projected drift vector in said memory; and
k. upon receiving an input from said user specifying a target, displaying said projected drift vector on said graphical display by placing said projected drift vector start point on said target and extending a drift line away from said target along said second heading.

11. A navigation aid as recited in claim 10, further comprising making the length of said drift line proportional to the length of said projected drift vector.

12. A navigation aid as recited in claim 10, further comprising displaying hashmarks along said drift line to indicate distance.

13. A navigation aid as recited in claim 11, further comprising displaying hashmarks along said drift line to indicate distance.

14. A navigation aid as recited in claim 10, further comprising:
a. providing a current depth to said computing device;
b. computing an anchoring distance corresponding to said current depth;
c. computing an anchoring position along said projected drift vector; and
d. displaying said anchoring position along said drift line.

15. A navigation aid as recited in claim 14, wherein said current depth is automatically provided to said computing device by a depth finding device.

16. A navigation aid as recited in claim 10, further comprising:
a. determining the length of time that has passed between the calculation of said projected drift vector and the present time; and
b. when said length of time that has passed between the calculation of said projected drift vector and the present time exceeds a predetermined limit, informing said user that said projected drift vector should be recomputed.

17. A navigation aid as recited in claim 10, wherein the interval between said first time and said second time is determined by said user.

18. A navigation aid as recited in claim 10, wherein the interval between said first time and said second time is determined by:
a. monitoring the distance between said first position and said second position; and
b. determining said second time to be the instant at which said distance between said first position and said second position exceeds a predetermined threshold.

19. A navigation aid allowing a user to predict the drift of a vessel, comprising:
a. determining a first position of said vessel at a first time;
b. determining a second position of said vessel at a second time which is later than said first time;
c. computing an actual drift vector starting at said first position and a first heading representing said change between said first position and said second position;
d. computing a projected drift vector having a start point lying on said first position and a second heading computed by subtracting 180 degrees from said first heading;
e. saving said projected drift vector in a memory;
f. at some point specifying a target; and
g. displaying said projected drift vector by placing said projected drift vector start point on said target and extending said projected drift vector away from said target along said second heading.

20. A navigation aid as recited in claim 19, further comprising making the length of said drift line proportional to the length of said projected drift vector.

21. A navigation aid as recited in claim 19, further comprising displaying hashmarks along said drift line.

22. A navigation aid allowing a user to predict the drift of a vessel, comprising:
a. determining a series of positions for said vessel over time;
b. computing an actual drift vector based on at least a portion of said series of positions, wherein said actual drift vector has a starting position and a first heading;
c. computing a projected drift vector having a start point and a second heading computed by subtracting 180 degrees from said first heading;
d. saving said projected drift vector in a memory;
e. at some point specifying a target; and
f. displaying said projected drift vector by placing said projected drift vector start point on said target and extending a drift line away from said target along said second heading.

23. A navigation aid as recited in claim 22, further comprising:
a. after said projected drift vector has been computed, determining a second series of positions for said vessel over time;
b. evaluating said second series of positions in order to determine if the drift of said vessel conforms to said projected drift vector; and
c. if said drift of said vessel does not conform to said projected drift vector, recomputing said projected drift vector.

24. A navigation aid as recited in claim 23, wherein when said projected drift vector is recomputed, said projected drift vector is recomputed using said second series of positions.

25. A navigation aid as recited in claim 1, further comprising:
a. determining a distance between said vessel and said drift line; and
b. displaying said distance between said vessel and said drift line.

26. A navigation aid as recited in claim 1, further comprising:
a. determining a current position for said vessel;
b. determining where said current position lies with respect to said drift line; and
c. providing a graphical steering prompt to inform said user which way to steer said vessel in order to intersect said drift line.

27. A navigation aid as recited in claim 19, further comprising:
a. determining a distance between said vessel and said drift line; and
b. displaying said distance between said vessel and said drift line.

28. A navigation aid as recited in claim 19, further comprising:
a. determining a current position for said vessel;
b. determining where said current position lies with respect to said drift line; and
c. providing a graphical steering prompt to inform said user which way to steer said vessel in order to intersect said drift line.
